(19) United States
(12) Patent Application Publication
(10) Pub. No.: US 2022/0237672 A1
(43) Pub. Date: Jul. 28, 2022

(54) System and method for automatically delivering custom product offers, creating bulk orders using virtual outfit catalog

(71) Applicant: Grace Tang, Stockton, CA (US)

(72) Inventor: Grace Tang, Stockton, CA (US)

(21) Appl. No.: 17/718,117

(22) Filed: Apr. 11, 2022

Related U.S. Application Data
(63) Continuation-in-part of application No. 16/892,254, filed on Jun. 3, 2020.

(51) Int. Cl. G06Q 30/06; G06Q 10/08

(52) U.S. Cl. CPC G06Q 30/0603; G06Q 10/087; G06Q 30/0633; G06Q 30/0643

(57) ABSTRACT

A system and method for automatic collecting, processing and combining custom product orders into bulk orders according to a procedure for storing custom product offers with adjustable price and configurable terms in virtual outfit catalogs of a virtual fitting system. Broadcasting the virtual outfit catalog to consumers in timeframes using the virtual fitting system, collecting orders from consumers. Automatically adjusting the product offers in the virtual outfit catalog for promoting the products and prototypes that received more orders. Upon receiving more orders than the minimum order quantity of a product or prototype, automatically converting the orders into a bulk order using the digital sale contract.

### CROSS-REFERENCE TO RELATED APPLICATIONS

This application is a continuation-in-part of application Ser. No. 16/892,254, filed 2020 Jun. 3, by the present inventor.

### BACKGROUND OF THE INVENTION

### 1. Field of the Invention

This invention relates generally to a system and method for automatically delivering custom product offers, combining custom product orders into bulk orders using virtual outfit catalog.

### 2. Description of Prior Art

It is challenging for vendors to produce custom products, sell custom products and gain profit. It is difficult to get large quantity of orders for higher quality custom products that have a higher price.

It is also very difficult for consumers to find the custom products they really like, products that tailored to their personal preferences. This invention offers a solution to solve this problem.

Custom products fulfill segmented market demand of a particular kind of products (FIG. 6). Custom production creates the platform for people to work and generate income using their creativity, talent, personal experience and style, making custom products for people who like these products.

Custom batch production allows the vendors and/or makers of these products to receive profits from making and selling these products, to sustain their businesses.

In general, it is more profitable to produce many products out of the same process, by duplicating the same prototype product. This enables the efficient usage of the production process; reducing the cost of producing each individual product. This is the reason why mass production can make profit by selling products at a low price.

For custom products, this is a problem. The cost of producing the prototypes of a new custom product, and enabling the manufacture process of the custom product is high. It takes a significant amount of resource, it can be the major cost of producing the custom products. (FIG. 7)

It is also difficult to market and sell custom products. The custom products are tailored toward specific personal preferences of individual consumers. Finding customers who really like the custom products and willing to purchase the custom products, grouping the custom orders into a bulk order is very difficult.

### SUMMARY OF THE INVENTION

In summary, this invention is a system and method for automatic collecting, processing and combining custom product orders into bulk orders according to a procedure for storing custom product offers with adjustable price and configurable terms in virtual outfit catalogs of a virtual fitting system. Broadcasting the virtual outfit catalog to consumers in timeframes using the virtual fitting system, collecting orders from consumers. Automatically adjusting the product offers in the virtual outfit catalog for promoting the products and prototypes that received more orders. Upon receiving more orders than the minimum order quantity of a product or prototype, automatically converting the orders into a bulk order using the digital sale contract.

### BRIEF DESCRIPTION OF THE DRAWINGS

For a more succinct understanding of the nature and objects of the present invention, reference should be directed to the following detailed description taken in connection with the accompanying drawings in which:

FIG. 1 is a diagram of an exemplary embodiment of the implementation of the virtual fitting system.

FIG. 2 is a block diagram of an exemplary implementation of the virtual fitting system according to one embodiment of the invention.

FIG. 3 is a diagram of an exemplary embodiment of the implementation of the virtual fitting system, illustrating the server and client components.

FIG. 4 shows an illustration of unit cost of a product is reduced by increasing the quantity of the products being produced in the production.

FIG. 5 shows an illustration of a product has multiple aspects that contribute to its final form.

FIG. 6 shows an illustration of the difference between mass production and batch production of custom products.

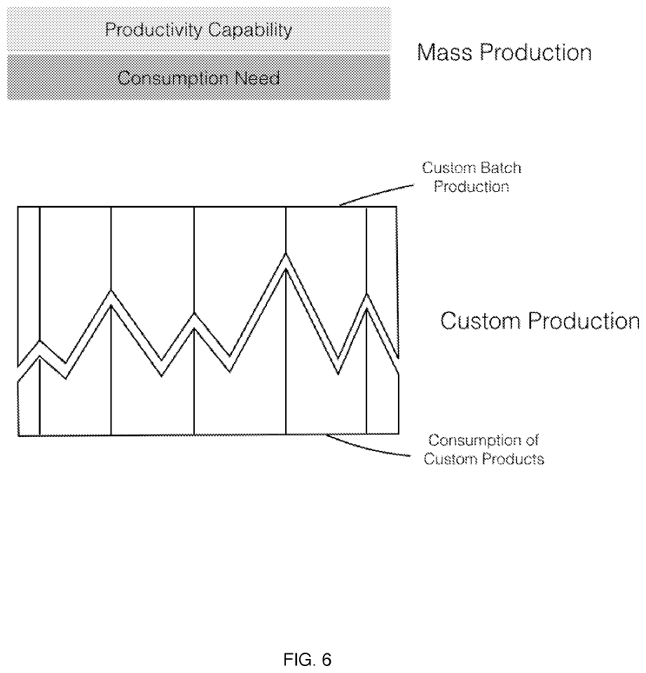

FIG. 7 shows an illustration of calculating the unit cost and price of a bulk produced product.

FIG. 8 shows an illustration of transaction momentum is reached between vendor and consumer, by reducing the price offered by the vendor to meet the price acceptable to the consumer.

FIG. 9 is a flowchart that shows a sequence of processes of a customer review the products offered in the virtual outfit catalog, order products using the digital sale contract in the virtual fitting system.

FIG. 10 shows an illustration of a product offer receiving few orders, getting removed from the virtual outfit catalog.

FIG. 11 shows an illustration of a product offer receiving not enough orders for reaching the minimum order quantity in a sale period.

FIG. 12 shows an illustration of a product offer receiving more orders than the minimum order quantity, generating bulk sale in the sale period.

FIG. 13 shows an illustration of product offer reaches the minimum and maximum order quantity in the sale period.

FIG. 14 shows an illustration of the virtual fitting system select and combine product orders into bulk orders, choosing the product options receiving more orders.

FIG. 15 shows an illustration of a graphical user interface on consumer electronic device, enabling the customer view the product offer and input user feedback.

FIG. 16 shows an illustration of a graphical user interface on consumer electronic device, let the customer selecting an acceptable price range using a slider, review and agree to the terms of the digital sale contact.

FIG. 17 shows an illustration of a graphical user interface on consumer electronic device, enabling the customer selecting the product options, select price range using a slider, review and agree to the terms of the digital sale contact.

FIG. 18 shows an illustration of a graphical user interface on vendor electronic device, enabling the vendor input information for the product offer, setting the price range of the product using a slider, review and sign the digital contact.

FIG. 19 shows an illustration of increasing the broadcasting frequency of a product offer in the sale period.

FIG. 20 shows an illustration of gradually reducing the price of the product within the price range, and gradually increasing the broadcasting frequency of a product offer in the sale period, using mathematical equations.

FIG. 21 shows an illustration of gradually reducing the price of the product within the price range using mathematical equations, receiving more product orders than the minimum order quantity.

FIG. 22 shows an illustration of gradually reducing the price of the product within the price range using mathematical equations, and gradually increasing the broadcasting frequency of a product offer in the sale period, using mathematical equations.

FIG. 23 is a diagram of an exemplary embodiment of the implementation of the virtual fitting system, illustrating the system having a plurality of virtual outfit catalogs waiting in the queue, automatically retrieving and sending them out to the client components in the virtual fitting system.

### DETAILED DESCRIPTION OF THE INVENTION

This invention is a system and method for automatic collecting, processing and combining custom product orders into bulk orders according to a procedure for storing custom product offers with adjustable price and configurable terms in virtual outfit catalogs of a virtual fitting system. Broadcasting the virtual outfit catalog to consumers in timeframes using the virtual fitting system, collecting orders from consumers. Automatically adjusting the product offers in the virtual outfit catalog for promoting the products and prototypes that received more orders. Upon receiving more orders than the minimum order quantity of a product or prototype, automatically converting the orders into a bulk order using the digital sale contract.

A virtual fitting system is a system that creates, processes and manages an image and data repository of a plurality of products, prototypes, apparels, accessories and etc. During the virtual fitting process, it loads and/or receives an image of the consumer through a consumer interface, processes the image, creates the visual result of the consumer wearing the apparels. By processing the images of the apparels and of the user, through image cropping, positioning, scaling, rotating, stretching, zooming, compressing, removing and/or replacing background, changing color and/or transparency and etc, the virtual fitting system generates the visual result of the user wearing the apparels.

Consumer can then review the graphical result and visualize he/her wearing the apparels, and decide whether an apparel fits his/her style and taste.

The system can be used to assist user to virtually try on apparels including clothing, accessories, purse, belt, hat, necklace, shoes, watch, jewelry, and etc. An apparel can be positioned graphically as desired with the image of the user, thus generates a virtual fitting visual effect.

Furthermore, the virtual fitting system are used to generate visualization result for fitting variations of products and prototypes with consumers' images. The virtual fitting system can display and/or virtual fit a list of products in an efficient manner using virtual outfit catalogs.

A virtual outfit catalog stores a plurality of images of products and prototypes, variations of colors and styles, and product data in memory images of products and prototypes, colors and styles and product data can be sorted and retrieved from the catalog.

A virtual outfit catalog can be uploaded, send, delivered and/or transferred through internet and/or cloud network from a server virtual fitting system to client virtual fitting systems, or transferred through peer-to-peer systems.

A virtual outfit catalog stores a plurality of images of products and prototypes, variations of colors and styles of products and prototypes, and product data in memory. Images of products and prototypes, colors and styles and product data can be retrieved from the catalog.

User can virtual outfit a list of virtual fitting images with placeholder configurations in a sequential manner, iterating through the list of products and prototypes in the virtual outfit catalogs. The virtual fitting system can display and/or virtual fit a list of products in an efficient manner.

Furthermore, through the virtual fitting system, the consumer can fit multiple apparels in sequence, using the virtual outfit catalog.

The virtual fitting system may be further configured for the consumer to virtual fit images of objects, apparels and/or environment to images of other objects, apparels, and/or environment captured, loaded, and/or selected by the consumer.

A virtual outfit catalog may be further configured for processing, organizing, sorting and storing the products and prototypes, variations of colors and styles of products and prototypes, and product data, based on criteria including but not limited to popularity of the products and prototypes, order quantity, pricing, size, color, style and other matrixes.

A virtual outfit catalog is configurable and can be adjusted dynamically based on market feedback.

Consumers can sign up for automatically receiving virtual outfit catalogs from the virtual fitting system using their electronic devices, including smart phones, iPads, tablets, desktops, laptops and other electronic devices that are connected to a network.

The virtual fitting system periodically broadcasts the virtual outfit catalogs to consumers in timeframes, adjusting the product offers in the virtual outfit catalogs and the list of virtual outfit catalogs for the broadcasting in the timeframes.

The virtual fitting system automatically broadcasts the virtual outfit catalogs to consumers in timeframes, storing a broadcasting frequency in the memory of the system. The virtual fitting system may increase the broadcasting frequency of popular virtual outfit catalogs. The virtual fitting system may decrease the broadcasting frequency of unpopular virtual outfit catalogs. The virtual fitting system may increase the broadcasting frequency of product offers that are close to reaching the minimum order quantity. The virtual fitting system may increase the broadcasting frequency of product offers that are on a major promotion. The virtual fitting system may automatically adjusting the broadcasting frequency based on one or a plurality of mathematical equations.

The virtual fitting system may use benchmark lines and/or benchmark mathematical equations to measure the performance of the product offers, automatically adjusting the broadcasting frequency based on the measured result.

The virtual fitting system may adjust the product offers in the virtual outfit catalog in each timeframe. The virtual fitting system may adjust the product offers in the virtual outfit catalog in each timeframe for enhancing the promotion of the products and prototypes that received more orders. The virtual fitting system may adjust the product offers in the virtual outfit catalog in each timeframe for enhancing the promotion of the products and prototypes that are more popular. The virtual fitting system may adjust the product offers in the virtual outfit catalog in each timeframe, hiding or removing products and prototypes that receive no or few orders from the catalog. The virtual fitting system may adjust the product offers in the virtual outfit catalog in each timeframe, reducing the price of products and prototypes within a price range in the sale period. The virtual fitting system may adjust the product offers in the virtual outfit catalog in each timeframe, reducing the price of products and prototypes, based on one or a plurality of mathematical equations. The virtual fitting system may adjust the price within the price range base on real-time market feedback in the sale period.

Consumers automatically receive the broadcasting messages and/or notification on their electronic devices, select the the virtual outfit catalogs they are interested in, retrieve or download the virtual outfit catalogs from the virtual fitting system. Consumers may view the products and prototypes stored in the virtual outfit catalogs, virtually outfit the images of products and prototypes with consumer images using the virtual fitting system.

Consumers may review the graphical result and visualize he/her wearing the products and prototypes, and decide whether a products and prototypes fits his/her style and taste.

Consumer may select the color, style and variation of a product or prototype for ordering the product or prototype.

Consumer may select the price that is acceptable for him or her to buy the product or prototype. Consumer may set the price range that is acceptable for him or her to buy the product or prototype, using a user interface configuration that is provided by the virtual fitting system. The user interface configuration may include a slider, a yes checkmark, checkbox, button and other user interface components.

Consumer may input customization request, redesign the apparel, redesign prototypes, add, remove, and/or replace components and/or features of the products or the prototypes. Consumer may leave reviews and feedback, order and/or order the apparels, as well as conduct other consumer interaction activities by using the user interface provided by the virtual fitting system.

Consumer may enter, review, comment, and provide feedback on the products or the prototypes, to communicate with provides, vendors, designers and/or other corresponding parties using the user interface provided by the virtual fitting system.

The virtual fitting system may be further configured for vendors and/or designers to interact with the consumer, facilitating vendors and/or designers to refine and make variations of the products and prototypes based on feedback and/or reports received from the consumer.

The virtual fitting system may be further configured for collecting feedback and/or custom design inputs from the consumer, process and consolidate data received, generate summarized representations using charts, tables, diagrams, graphical images and reports.

The virtual fitting system may be further configured for the consumer to virtual fit images of objects, apparels and/or environment to images of other objects, apparels, and/or environment captured, loaded, and selected by the consumer. For example, The virtual fitting system may be configure for the consumer to visualize how a list of carpets look like in his living room, by virtually placing them in his living room using a photo of his living room using the virtual fitting system.

A virtual outfit catalog is further configured for using digital sale contracts to manage and process the orders of products and prototypes.

A digital sale contract is stored or linked in the virtual outfit catalog. The digital sale contract is a legal contract created based on a legal template document, configured with placeholder entries, adjustable conditions and terms.

A plurality of legal template documents are created and provided by legal professionals. The template documents contain placeholder entries, adjustable conditions and terms. The template documents are uploaded and stored in the memory of the virtual fitting system or linked to the virtual fitting system.

Vendor may chose a legal template document that he/she wants to use, and created the digital sale contract based on the legal template document.

Vendor enters the product offer using the vendor user interface of the virtual fitting system, creates a digital sale contract with configurable price and terms using a legal template document, storing with the images of products and prototypes and product data in a virtual outfit catalog, wherein the contract includes at least a minimum order quantity, sale period, price range, conditions and terms.

A product offer is removed from the virtual outfit catalog after the sale period of the product offer ends. A product offer may be automatically removed from the virtual outfit catalog after the sale period of the product offer ends, or removed when receiving few or none product orders.

Consumer's purchase intents vary from time to time. For many consumers to maintain their purchase intents for a custom product, and their decisions to purchase, the transaction has to be facilitated and completed in an organized manner under defined terms. A digital sale contract is used to maintain the agreement of a consumer agreement of purchasing the product under predefined conditions, and the vendor agreement of selling the product under defined terms and conditions, within the sale period.

A digital sale contract facilitate the selling process. Upon receiving more orders than the minimum order quantity of a product or prototype, the orders are automatically converted into a bulk order using the digital sale contract, wherein the bulk order include at least the image, price and quantity of the product or prototype.

A configurable digital sale contract has flexible terms, adjustable price within a price range defined by the vendor. The digital sale contract is further configured with conditions for selecting and using the terms to complete the contract. Upon meeting all conditions, the contract becomes an executed binding legal contract, a mutual agreement between the vendor and the consumer.

Convertible Digital Contracts are based on legal contract templates with a plurality of terms. The terms include the date and time of the creation of the contract, expiration date of the contract, seller's terms, variations of products, price range of the products agreed by the seller, the condition under which the contract becomes an executed legal binding purchase and sale agreement, and the condition under which the contract becomes void or expires.

The digital sale contract is included in the product offer. Consumers review the products and prototypes, variations of product options, virtual outfitting them with their photos, chose the products and prototypes they like, review the digital sale contract, the price range of the products and other terms in the digital sale contract. Consumer sign the digital sale contract and entering into an initial agreement of purchasing the products they have selected. This initial agreement can be defined as order that could be voided if the conditions and terms in the contract are not met. Preorder is a type of order, and is referred to as a preliminary order in this application. Product order can be automatically converted into product sale when the conditions and terms of the contract are met.

When the conditions and terms under which the contract becomes an executed legal binding agreement are met, this digital sale contract automatically becomes an executed legal binding purchase and sale agreement between the vendor and consumer.

The digital sale contract may be setup with an escrow account and/or digital wallet, consumers may deposit fund into the escrow account and/or digital wallet when they sign the initial agreement. When the conditions under which the contract becomes an executed legal binding purchase and sale agreement are met, the fund may be transferred and/or withdrawn by the vendor, and vendor will have the obligation to produce and deliver the product to the consumer.

In another configuration, the fund may be held in the escrow account and/or digital wallet, upon the vendor making and delivering the product to the consumer, the fund is released and/or transferred to the vendor.

The conditions under which the contract becomes an executed legal binding purchase and sale agreement are recorded in the digital sale contract.

The conditions may include that only when the order quantity of the product surpasses the minimum order quantity defined by the vendor, will the contract becomes an executed legal binding purchase and sale agreement. If at the end of the sale cycle and/or sales campaign, vendor has received too few orders for a product, and the order quantity is less than the minimum order quantity, the condition is not met. At the end of the sale period, when the minimum order quantity is not met, unless the vendor agrees to reconfigure the terms, all matching pending sales orders will be automatically canceled. The funds that the consumers have deposited in the escrow account and/or digital wallet are automatically refunded to the consumers.

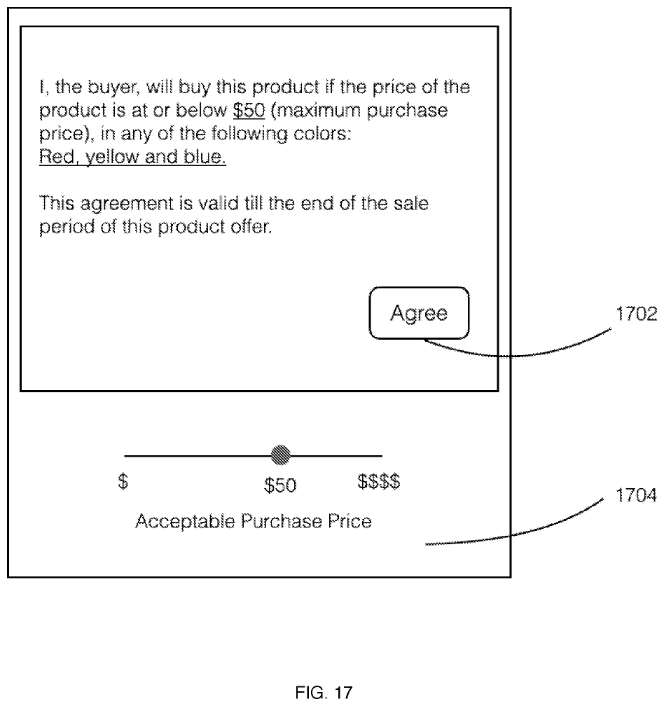

The terms in the digital sale contract may include that the consumer chooses a plurality of product options when entering the initial agreement to purchase the product, intending to purchase one product out of the selected product options (FIG. 17). At the end of the sale cycle and/or sales campaign, if one of the product options has higher order quantity, vendor may chose to make and deliver that product option to the consumer. The vendor and the buyer will not need to reconsider or redo the purchase and sale agreement. The initial sales agreement is automatically converted into an executed binding purchase and sale agreement of that product option.

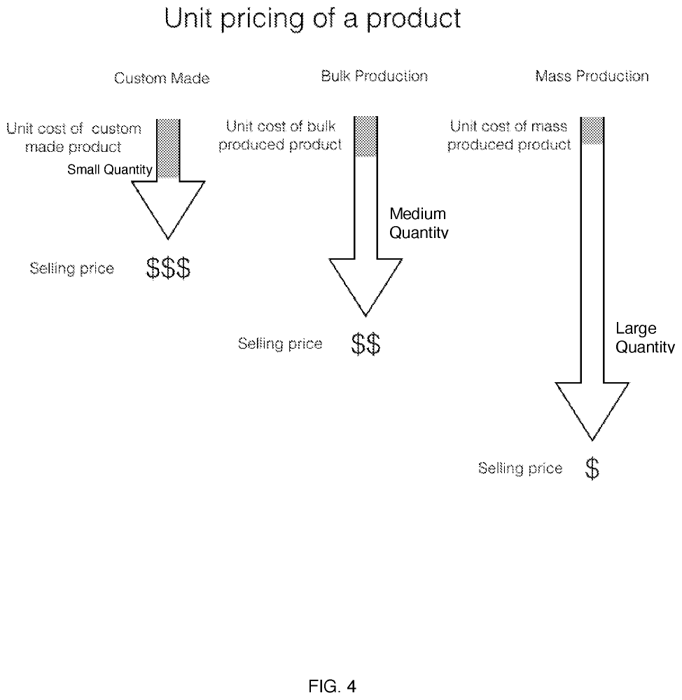

In the production process, in general, it is more profitable to make many products using the same process. This increases the cost efficiency of the production process; reduce the production cost of each individual product. For batch produced products, increase the product order quantity often reduces the unit cost of the product. (FIG. 4).

Cost of batch production of products/Quantity=Unit cost of product

Price of bulk sale of products/Quantity=Unit price of product

For the consumers, the acceptable price for them to purchase a product largely depends on the perceivable value of the product. Customers are willing to pay a higher price for products they really like, that are customized and made based on their personally preferences.

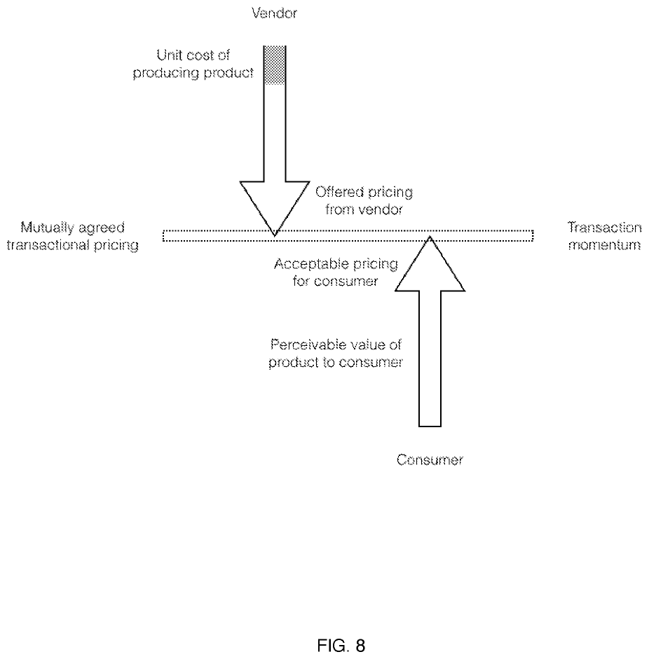

To reach a mutual agreement on the purchase and sale of a product, the product needs to he sold at a price that is acceptable by the consumers, and it also need to be sold at the price that is acceptable by the vendor, who needs to receive a profit from the sale. Usually, selling more products reduces the unit cost of the product, and increase the profit for the vendor (FIG. 8).

Accumulating individual product orders into bulk orders will lower the unit cost of the product, helping reaching a mutually agreed price of the product between the vendor and the consumers, for the transaction to take place.

It helps the vendor to become more profitable by finding and producing products and prototypes with market fit, increasing the perceivable value of the products for the customers, so that they will be willing to pay more for the enhanced product.

For consumers, the perceived value of the product influences how much a consumer willing to pay for the product. When a customer really likes a product or prototype, he or she is willing to pay more for the product or prototype.

The transaction takes place when a mutually agreed on value of the product is reached between the vendor and the consumer, when the consumer agrees to pay for the price of the product, in exchange of the product and receiving the perceivable value of the product. (FIG. 8)

When the vendor prepares the product offer for selling products and prototypes, he/she need to do a financial analysis and calculate how much is the cost of producing a batch of products, and how many products he/she can produce in that batch. Based on this information, the vendor can calculate what's the unit cost of the product, and what is the minimum sale price for that product.

In general, when more products are produced out of the same production process, it reduces the unit cost of production for each individual product. It is more likely for the vendor to make profit out of bulk producing and selling products.

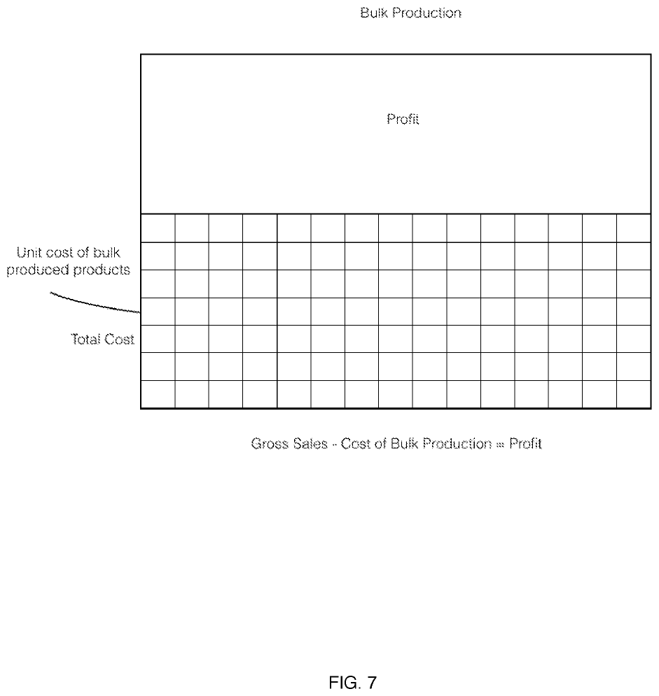

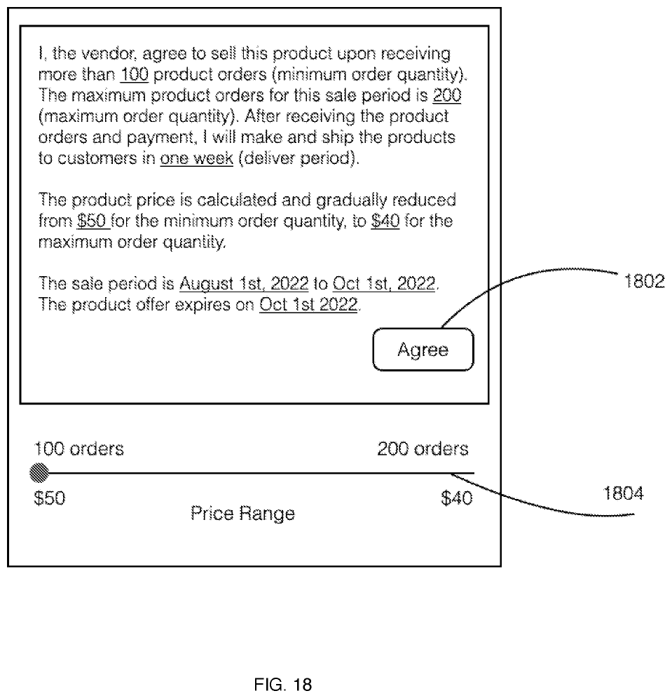

The vendor calculates the cost of producing a batch of products, adding in the minimum profit he/she would like to get, and calculate the gross sales revenue he/she needs to receive for the batch of products (FIG. 7). Vendor estimates the amount of products he/she can produce and deliver to customer within reasonable timeframe, set the sale period for the product offer. Vendor set the minimum order quantity for the product offer to ensure that he/she will receive the minimum sales revenue from the sale. Vendor may also set a maximum order quantity of the products and prototypes for the sale period (FIG. 18).

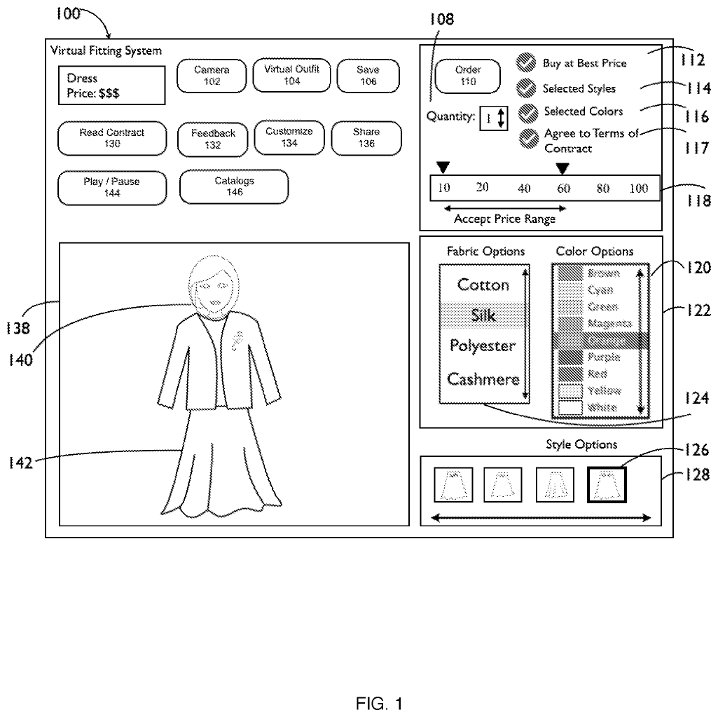

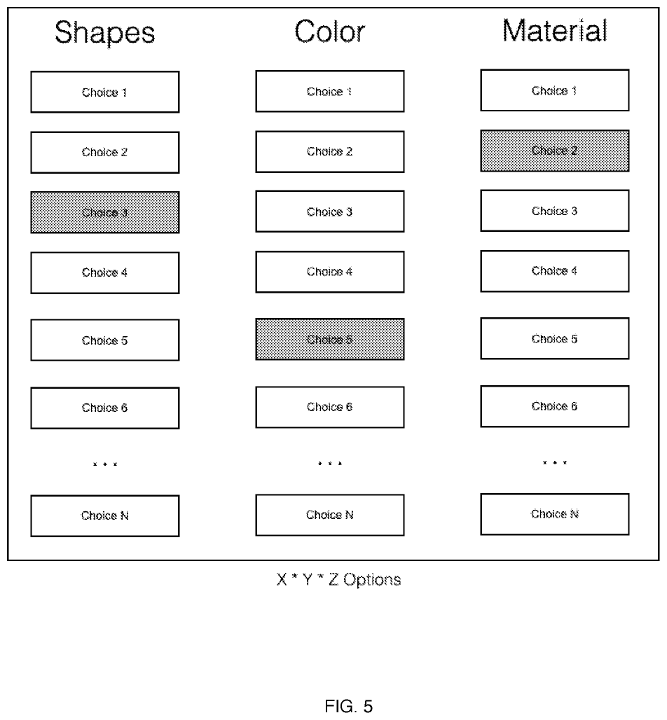

A product has multiple aspects that contribute to its final form. The color, style, fabric, shape, material, structure, texture and etc are among these aspects (FIG. 5). Finding out what is best combination of elements that produces the optimal result, producing a best selling product that are liked by many consumers, generating more sales revenue is important. It requires the vendors to have the expertise, refined taste, creativity and years of experience. The system and method described in this invention helps vendors finding the best selling products and prototypes using virtual outfit catalogs in a virtual fitting system (FIG. 1).

It is like a pianist playing different tunes on a piano, trying to find the perfect tune that is most delightful for the audience. This invention helps product makers to define and adjust their custom products based on consumers' feedback, and facilitate the sell of custom products by automatically delivering custom product offers to consumers, collecting and combining custom product orders into bulk orders using virtual outfit catalog in a virtual fitting system.

This invention will also help the consumers receive a diverse spectrum of creative custom products, find the ones they really like and make the purchase at a price acceptable for them.

This invention is a system and method for automatic collecting, processing and combining custom product orders into bulk orders according to a procedure for storing custom product offers with adjustable price and configurable terms in virtual outfit catalogs of a virtual fitting system. Broadcasting the virtual outfit catalog to consumers in timeframes using the virtual fitting system, collecting orders from consumers. Automatically adjusting the product offers in the virtual outfit catalog for promoting the products and prototypes that received more orders. Upon receiving more orders than the minimum order quantity of a product or prototype, automatically converting the orders into a bulk order using the digital sale contract.

Consumers sign up to the virtual fitting system, automatically receiving custom virtual outfit catalogs based on their personal preferences. Vendors offers a variety of product offers and delivering them to consumers using virtual outfit catalogs of the virtual fitting system. Vendors get real-time market feedback regarding the market fit of the products and prototypes based on the number of orders and/or feedback they received from the consumers using the virtual fitting system. The system periodically broadcasting product offers and virtual outfit catalogs to consumers in timeframes, promoting product offers from different vendors, delivering a variety of virtual outfit catalogs to consumers, helping vendors offer a diverse spectrum of products and prototypes to the consumers. The system helps vendors define and refine their best selling products, facilitate the order and the selling process of the products, helping complete bulk ordering and transaction of the products. The system help finding the optimal prices of products and prototypes that is mutually acceptable to the vendors and the consumers.

A product offer has a bundle of information, offer products and prototypes that can be produced and delivered to consumers. It includes images, graphic, data, url links that are related to the products and prototypes that are being promoted. It helps consumers to review, visualize and select products and prototypes base on their personal preferences. This helps consumers finding and buying the products and prototypes they really like. This also helps the vendors to make products on-demand, based on consumer feedback.

As shown in FIG. 1, a virtual fitting system creates, processes and manages an image and data repository of a plurality of products, apparels, accessories and etc. During the virtual fitting process, it captures an image of the consumer using a camera 102 connected to the system, processes the image, creates the visualization graphical result of the consumer wearing the apparels 138. By processing the images of the apparels 142 and the image of the consumer 140, through image cropping, positioning, scaling, rotating, stretching, zooming, compressing and etc, the virtual fitting system generates the visual result of the consumer wearing the apparels 138. Consumer can then review the graphical result and visualize he/her wearing the apparels 138, and decide whether the apparel fits his/her style and taste. Consumer may select the colors they like from the color options provided by the system 120. Consumer may select the type of fabric they like from the fabric options provided by the system 124. Consumer may select the styles they like 126 from the style options provided by the system 128. Other product options are also provided on the user interface for the consumer to review and chose. Consumer may load an image to the system, or use the camera 102 of the virtual fitting system 100 to take a selfie. Consumer may click the virtual outfit button 104 to start the virtual fitting process. Consumer may browse the virtual outfit catalogs available using the catalogs button 146, select a virtual outfit catalog and load the virtual outfit catalog using the virtual fitting system 100. The virtual fitting system may iterate through the virtual outfit images stored in the virtual outfit catalog, and creating the visual result of the consumer wearing various apparel in a sequential manner. The virtual fitting system may iterate through all the virtual outfit images stored in the virtual outfit catalog after consumer initiates the virtual fitting process. Consumer may start, pause, stop and reset a virtual fitting process 144. Consumer may save the virtual outfit result using the save button 106, consumer may share the virtual fitting photo, the virtual fitting catalog or other messages with other people using the share button 136.

Consumer may select the price that is acceptable for him or her to buy the product or prototype. Consumer may set the range of price that is acceptable for him/her to buy the product using a slider 118. Consumer may set the terms of the contract under which he/she agrees to buy the product using the checkmarks or checkboxes 112, 114 and 116 provided on the user interface of the virtual fitting system 100. Consumer may read and review the digital sale contract by clicking the read contract button 130. Consumer may choose to agree with the terms of the digital sale contract by clicking on the checkmark, checkbox or button 117. Consumer may select the quantity of products that he/she would like to order using selector or slider 108. Consumer may order the products and prototypes using the order button 110.

Consumer may send feedback to the vendor, designer and/or other corresponding parties using the feedback button 132. Consumer may further customize the products and prototypes using the customize button 134.

The virtual fitting system also provides a vendor user interface. Vendors load images of products and prototypes, product data, variations of colors and styles, sale period, minimum order quantity, price range and other terms for a product offer from a vendor user interface. In response to the vendor entering the product offer using the user interface, the virtual fitting system creates a digital sale contract with configurable price and terms, storing with the images in a virtual outfit catalog, wherein the contract includes at least a minimum order quantity, sale period, price range and terms.

Consumers are able to receive notifications of available virtual outfit catalogs using the virtual fitting system. Consumers may chose to subscribe and receive a data feed of available virtual outfit catalogs using the virtual fitting system.

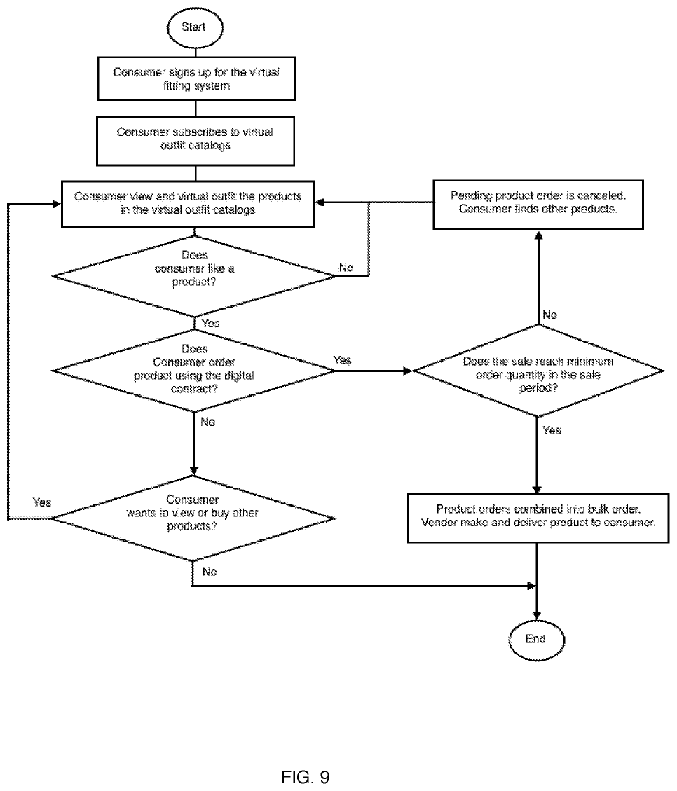

The virtual outfit catalogs are dynamically updated based on the product offers, promotions and updates available. Consumers may download and install the client application of the virtual fitting system on their electronic devices. Consumers may automatically receives notifications of virtual outfit catalogs available on their electronic devices from the virtual fitting system. Consumers may select, load and view the virtual outfit catalogs using the virtual fitting application on their electronic devices. Consumers may take pictures of themselves using the cameras of their mobile phones, or load photos to the virtual fitting application, virtual fitting products and prototypes using the virtual outfit catalogs on their electronic devices (FIG. 9).

The virtual fitting system is like a pianist is playing the piano at a radio station. He/she changes his/her tunes from time to time. Consumers turn on their client programs on their personal electronic devices, listen to the tunes, choose and order for the tunes they like best. These orders are sent to the radio system. When a certain tune receives enough orders, it passes the market test and gets to be composed and completed into the final music album. The radio station let different pianists play different tunes at different timeframes. It also serves different radio channels tailored towards the tastes of different audience groups. Consumers sign up and choose different radio channels to listen to, based on their personal preferences. In the virtual fitting system described in this invention, the styles of the fashion, apparel or other consumer goods are like the music, being communicated to the consumers using virtual outfit catalogs, helping vendors and designers finding the products that have the best market fit.

Products and prototypes have many options including the style, shape, color, material, texture and etc (FIG. 5). It is better for a vendor to create and sell new products that are liked by many consumers based on market feedback; than trying to promote a lesser product that not many people want to buy.

In the virtual fitting system, product offers that receive few or no orders are removed and/or hidden from the virtual outfit catalogs.

Removing non-performing product offers from the virtual outfit catalogs prevents the system from being congested with old, low quality product offers. This will allow the system always offer fresh, new product offers in the virtual outfit catalogs, and facilitate a diverse, dynamic, energetic market.

The virtual fitting system has server components and client components, server applications and client applications.

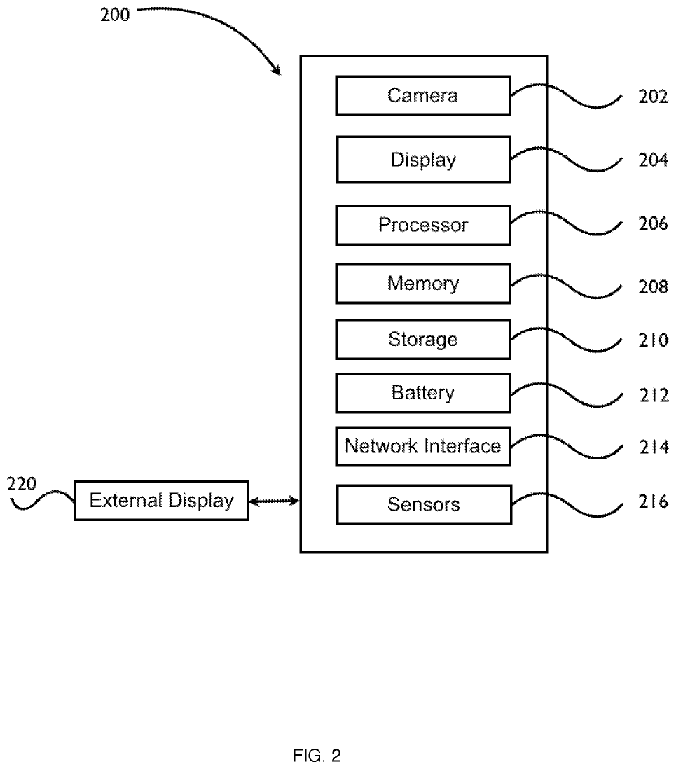

With reference to FIG. 2, an embodiment of the virtual fitting system is described herein as the one shown in FIG. 2. The server and client components of the virtual fitting system may execute as or on a touch screen mobile device such as a phone or tablet, a touch screen TV with computation capability, a computer system, and/or other possible multi-media devices with computation capability.

In its most basic configuration, virtual fitting system 200 comprises at least one processing unit or processor 206 and system memory 208, a camera 202, a touch screen display 204. In embodiments, data and images are loaded into memory 208 and executed by the processing unit 206 from system memory 208. Depending on the exact configuration and type of system 200, memory 208 may be volatile (such as RAM), non-volatile (such as ROM, flash memory, etc.), or some combination of the two.

Additionally, virtual fitting system 200 may also have other components. For example, virtual fitting system 200 includes additional media storage 210, such as removable and/or non-removable media storage, including SD memory card, magnetic or optical disks or tape. The virtual fitting system 200 may have battery 212 to provide power when not connected to an external power source.

The virtual fitting system 200 may have input component such as graphic drawing pad, mouse, keyboard and etc. The display 204 may be embedded with touch sensors, thus function as a touch screen display. The virtual fitting system 200 may have output component, which handles the displays and transfer of both image and data outputs from the virtual fitting system to other devices and/or systems. The virtual fitting system 200 may have sensor component(s) 216, such as touch sensor, light sensor, GPS sensor, near field communication sensor and/or etc to handle the sensing, receiving and transferring of data.

The virtual fitting system 200 may use an external display 220 to provide better visualization result, such external display 220 can be a TV, a projector device and/or etc. The external display 220 may be connected with the virtual fitting system 200 through wiring or wireless connections including but not limited to Wi-Fi, blue-tooth connection and/or etc.

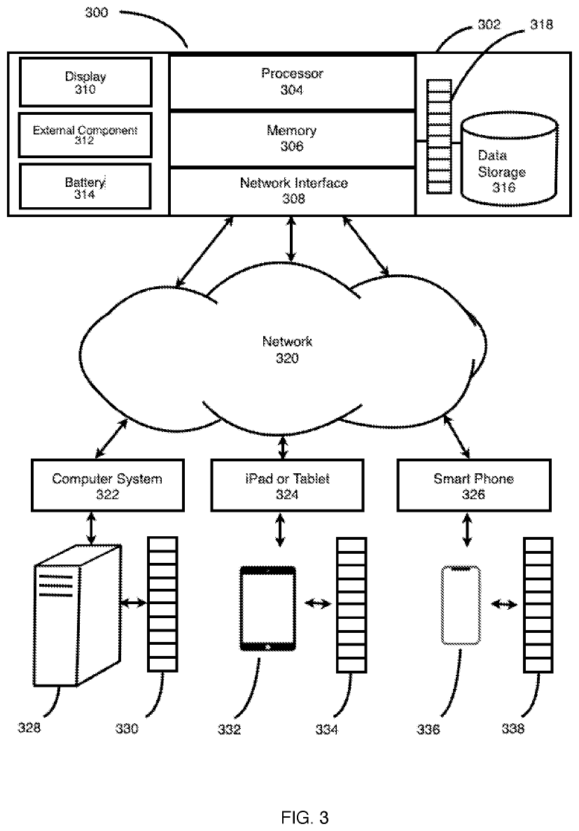

As shown in FIG. 3. The virtual fitting system has server components 300 and client components 322, 324 and 326. In its most basic configuration, the server component of the virtual fitting system 300 comprises at least a processing unit or processor 304 and system memory 306, a touch screen display 310, and data storage 316. Data and images are loaded into memory 306, processed by the processing unit 304, and stored in data storage unit 316. Depending on the exact configuration and type of system 300, memory 306 may be volatile (such as RAM), non-volatile (such as ROM, flash memory, etc.), or some combination of the two.

The server components of the virtual fitting system may execute as or on a touch screen mobile device such as a phone or tablet, a computer system, and/or other possible multi-media devices with computation capability.

The client components of the virtual fitting system may execute as or on a touch screen mobile device such as a smart phone 336, iPad or tablet 332, a computer system 328, and/or other possible multi-media devices with computation capability.

The server components and the client components of the virtual fitting system are connected through wiring or wireless connections. Virtual outfit catalogs 318 can be uploaded, send, delivered and/or transferred through internee and/or cloud network 320 from a server virtual fitting system to client virtual fitting systems, or transferred through peer-to-peer systems.

Consumers may sign up to the virtual fitting system, download and install the client application of the virtual fitting system, and receiving virtual outfit catalogs on their smart phones 336, iPads or tablets 332, or computer systems 328. Consumers may subscribe and/or download the virtual outfit catalogs 330, 334 and 338 that fits their personal preferences on their electronic devices.

The server virtual fitting system 300 automatically broadcasts a plurality of virtual outfit catalogs 318 to consumers in timeframes, adjusting the product offers in the virtual outfit catalogs and the list of virtual outfit catalogs in each broadcast.

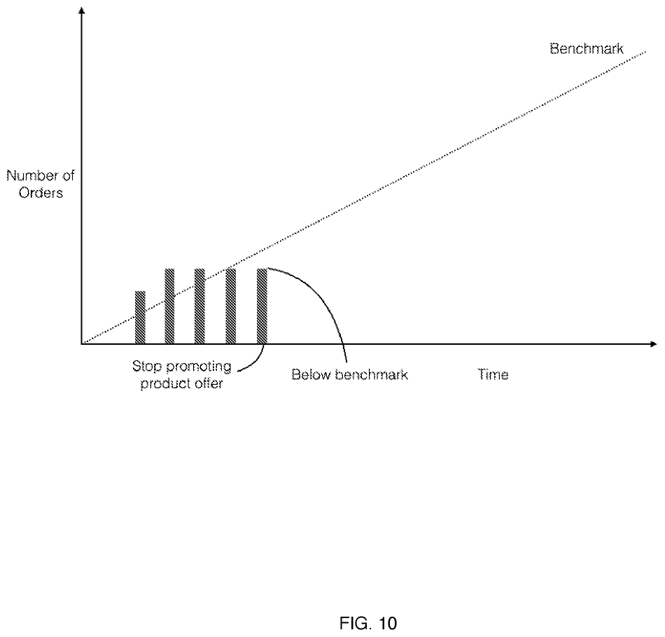

As shown in FIG. 10, a product offer is included in a virtual outfit catalog, being repeatedly broadcasted to the consumers from time to time using the virtual outfit system. By the 5^{th} time that it is promoted on the system, the real-time market feedback shows that it receives very few orders from consumers, performing below the benchmark, and unlikely to reach the minimum order quantity in the sale period. The product offer is removed from the virtual outfit catalog. The feedback from the market is sent to the vendor, he/she will redesign the product, adjust and reconfigure the product offer.

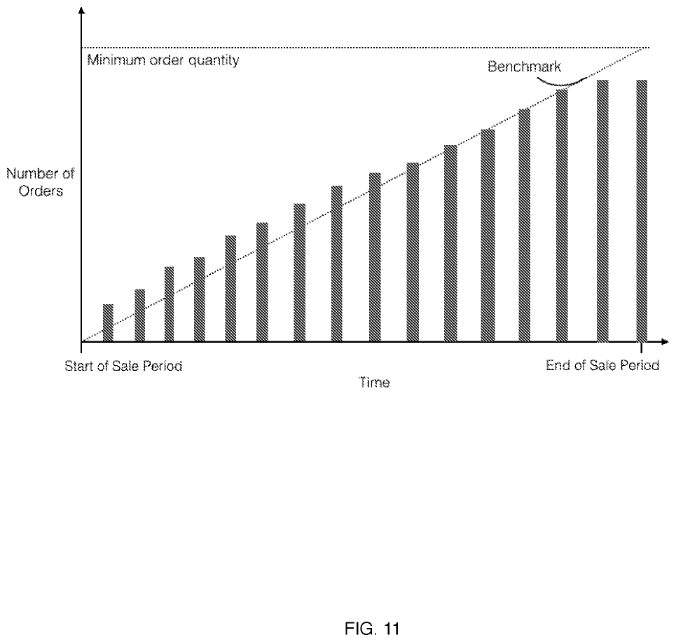

As shown in FIG. 11, a product offer is included in a virtual outfit catalog, being periodically broadcasted to the consumers from time to time using the virtual outfit system. The product offer receives a plurality of orders from the consumers, the quantity of orders passes the benchmark in the earlier part of the sale period. But when the sale period ends, the order quantity fail to reach the minimum order quantity. The result is sent to the vendor, and the vendor may chose whether he/she wants to proceed with the sale or cancel the sale orders.

If the vendor chose to cancel the sale orders, because of the term of the minimum order quantity is not met in the digital sale contract, all pending sale orders are automatically canceled and/or voided. The fund that has been deposited by the consumers in the escrow account and/or digital wallet are automatically refunded to the consumers.

If the vendor chose to proceed with the sale, he/she may update the term of the minimum order quantity in the digital sale contract, matching the order quantity received, and reconfigure the contract. Upon the terms and conditions are met in the digital sale contract, all pending sale orders are automatically converted into binding purchase and sale agreements between the vendor and the consumers. The fund that has been deposited by the consumers in the escrow account and/or digital wallet may be automatically released to the vendor according to the terms of the contract.

The digital sale contract may be configured as immutable or unchangeable, preventing any alternation to the terms and conditions after the sale period start.

The digital sale contract may be configured as mutable or configurable before a defined date and time, allowing alternation to the terms and conditions in a timeframe, such as between the start of the sale period and ends at the defined date and time.

A product offer has an expiration date, recorded in the digital sale contract of the product offer. Expired product offer is removed from the virtual outfit catalog.

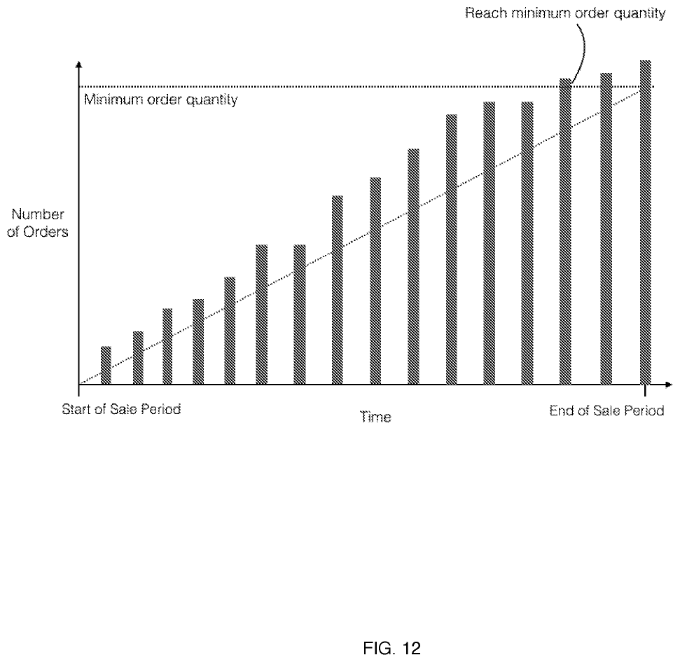

As shown in FIG. 12, a product offer is included in a virtual outfit catalog, being periodically broadcasted to the consumers from time to time using the virtual outfit system. The product offer receives good market feedback, reaching the performance benchmark and minimum order quantity in the sale period. The products orders are combined into a bulk order. The vendor receives the bulk order, make and deliver the finished products to the customers.

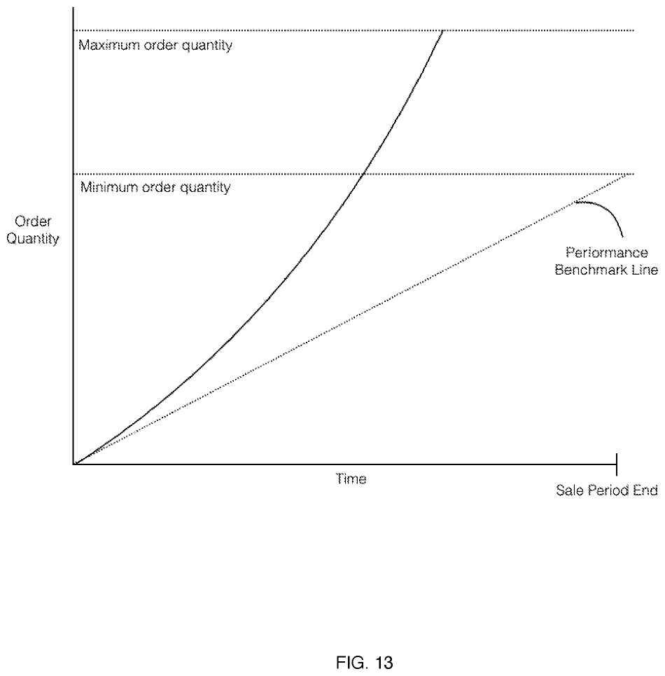

As shown in FIG. 13, a product offer is included in a virtual outfit catalog, being repeatedly broadcasted to the consumers from time to time using the virtual outfit system. The product offer receives good market feedback, reaches the minimum order quantity in the sale period. The order quantity also reaches the maximum order quantity in the sale period. The vendor receives the orderings from the customers, complete the sales agreement, fulfill these orderings, and deliver the products to the customers.

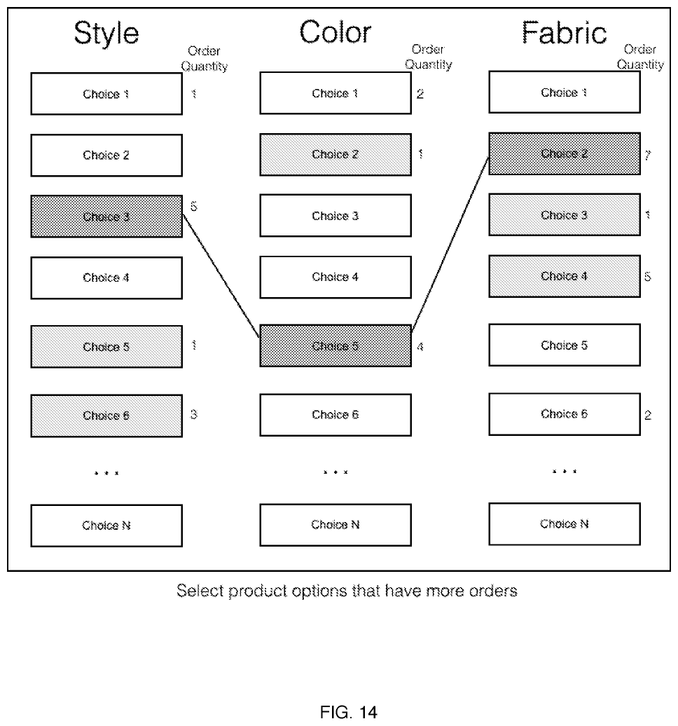

As shown in FIG. 14, the virtual fitting system automatically select and combine product orders into bulk orders, choosing the product options that have received more orders.

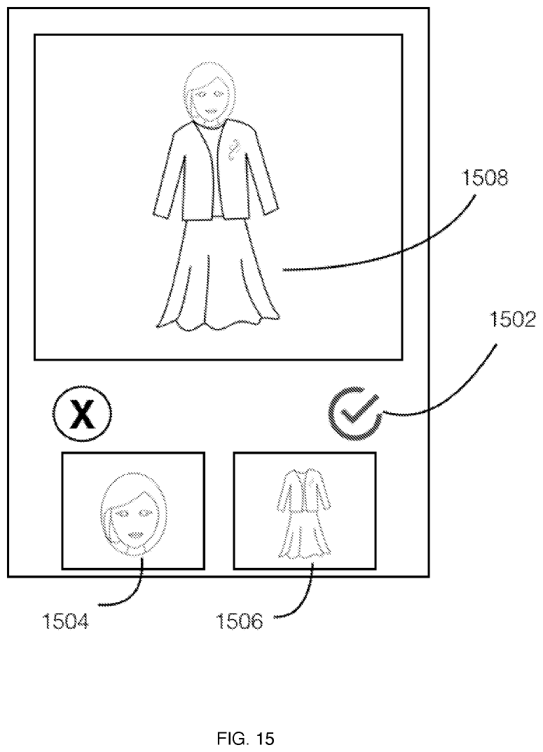

As shown in FIG. 15, a consumer receives a product offer in a virtual outfit catalog on her electronic device. She review the products and prototypes in the product offer, virtual outfitting the products and prototypes using the virtual outfit images 1506 included in the virtual outfit catalog with her photo 1504, reviewing the visual result of her wearing the product. She like the result and click the checkmark button 1502 to like and/or order the product.

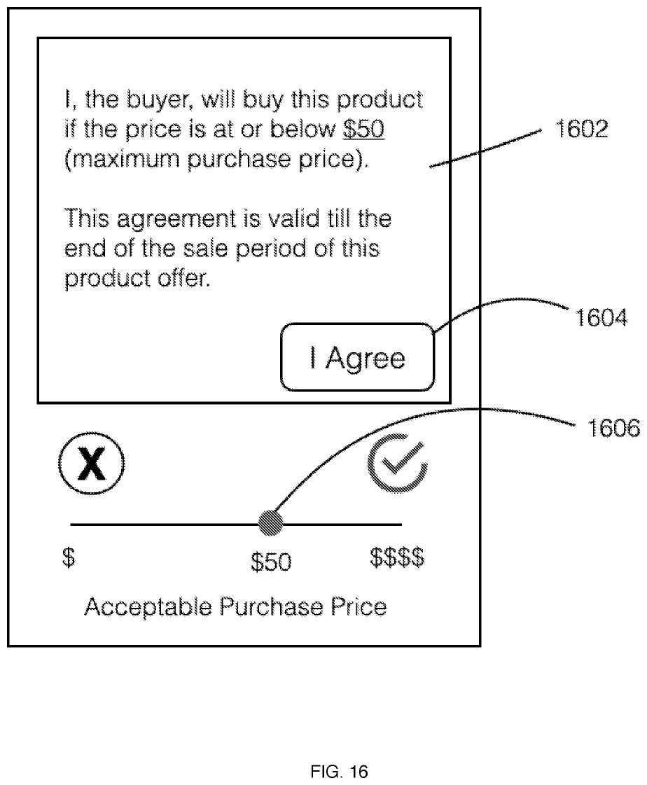

As shown in FIG. 16, a consumer receives a product offer in a virtual outfit catalog on his/her digital device, he/she review the information and like the product. He/she clicks the order button 110. The system automatically displays the price and terms of the product offer on the graphical interface of the digital device 1602. The consumer uses the slider 1606 and set the price range at which he/she is willing to buy the product. The consumer review the terms of the digital sale contract and agree to the terms by clicking the agree button 1604 to place the order.

As shown in FIG. 17, a consumer receives a product offer in a virtual outfit catalog on his/her digital device, he/she review the product offer and proceed to order the product. The system automatically displays the price and terms of the product offer on the graphical interface of the digital device 1704. The consumer selects the product options for the order, and the buyer's acceptable price range. The consumer review the terms of the digital sale contract and agree to the terms by clicking on the agree button 1702 to place the order.

As shown in FIG. 18, a vendor wants to sell a product upon receiving orders more than a minimum order quantity at the end of the sale period. He/she enters the terms of his product offer, along with the images, photos, data, url links and etc associated with the products and prototypes on the virtual outfit system. The vendor enters the minimum order quantity and the maximum order quantity, the sale period of the product offer. The vendor enters the price range of the product using a slider configured for this purpose 1804, agreeing to sell the product or prototype for a price within the price range. The system automatically generates a digital sale contract, using a legal template selected the vendor and specifically created for this type of transaction, completed with the vendor's conditions and terms. Vendor review the digital sale contract generated. Vendor agrees to the digital sale contract by clicking on the agree button on the vendor user interface 1802, and proceed to sign the contract and post the product offer.

This transaction momentum are kept and maintained in the system within the sale period. As illustrated in FIGS. 16, 17 and 18, the agreements are maintained and valid for a set period in the digital sale contracts.

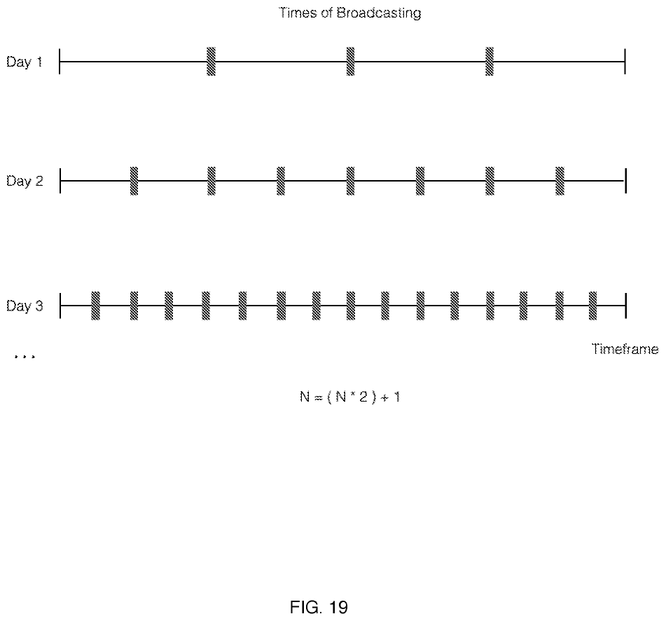

As shown in FIG. 19, the broadcasting frequency of a product offer is adjusted and increased in the sale period based on a mathematical equation of N=(N*2)+1. In each timeframe, the product offer is broadcasted with the virtual outfit catalog more frequently to the consumers, that it gets broadcasted more than twice as often as it was in the previous timeframe, until the end of the sale period.

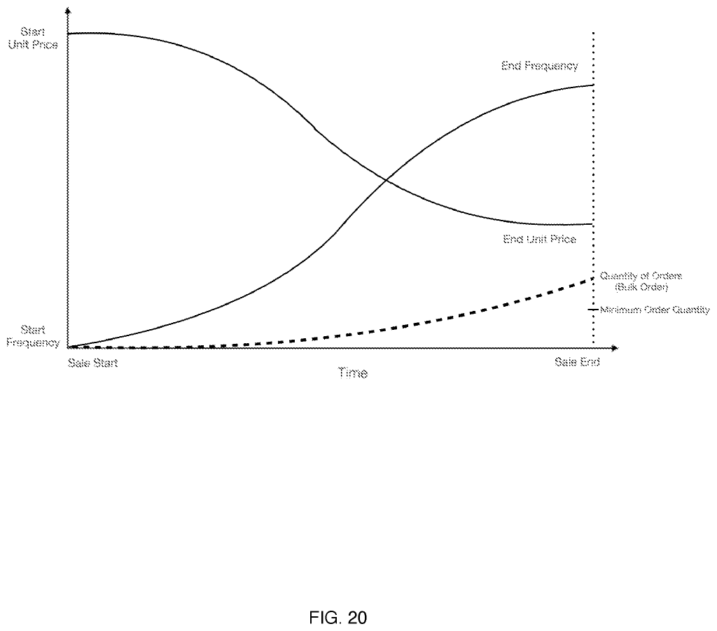

As shown in FIG. 20, the broadcasting frequency of a product offer is gradually increased in the sale period, while the price of the product is gradually reduced within the price range in the sale period. This enables the product offer to receive sufficient attention from the consumers, obtaining the sales momentum. The product receives more orders than the minimum order quantity at the end of the sale period, product orders are successfully combined into a bulk order, the sale is completed successfully.

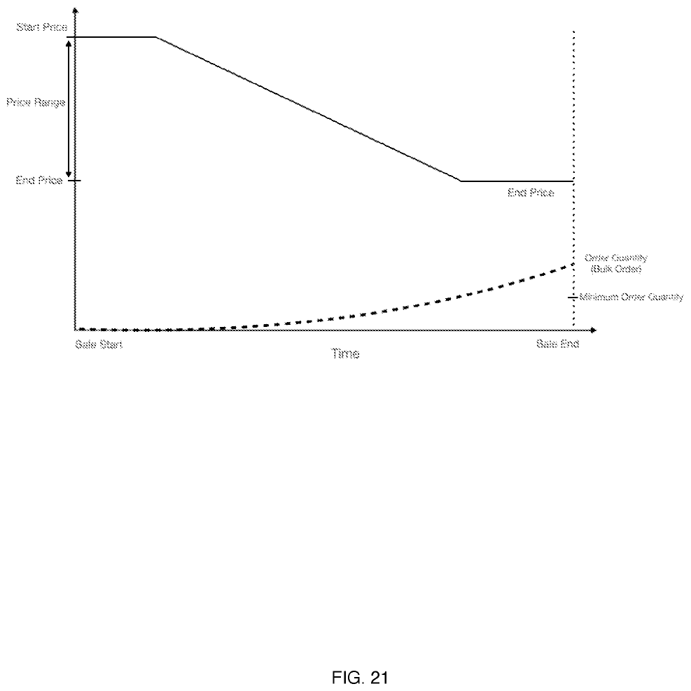

As shown in FIG. 21, the price of the product is automatically and gradually reduced within the price range in the sale period using linear equations. When the price is reduced to the minimum price set by the vendor, the price is maintained at that number. The product receives more orders than the minimum order quantity at the end of the sale period, product orders are successfully combined into a bulk order, the sale is completed successfully.

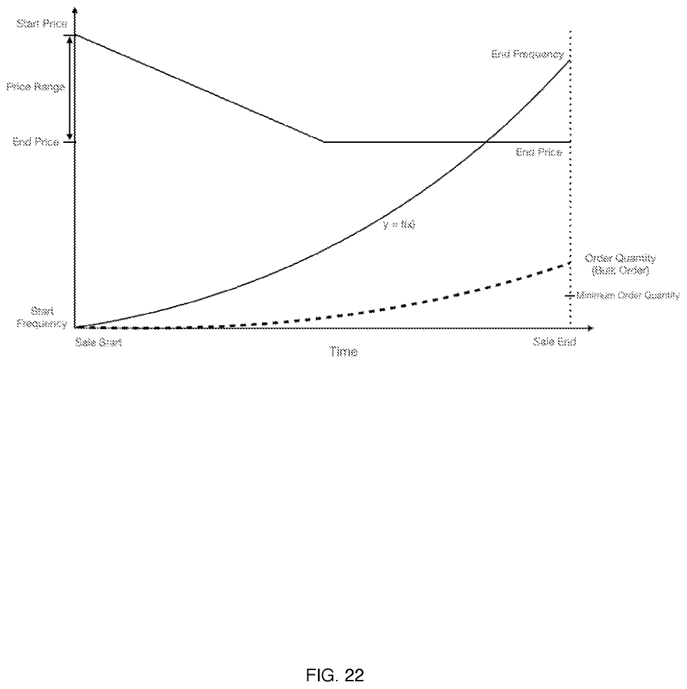

As shown in FIG. 22, the price of the product is automatically and gradually reduced within the price range in the sale period using a linear equation. When the price is reduced to the minimum price set by the vendor, the price is maintained at that number.

The broadcasting frequency of the product offer is gradually increased in the sale period based on a mathematical equation of y=f(x). The product receives more orders than the minimum order quantity at the end of the sale period, product orders are successfully combined into a bulk order, the sale is completed successfully.

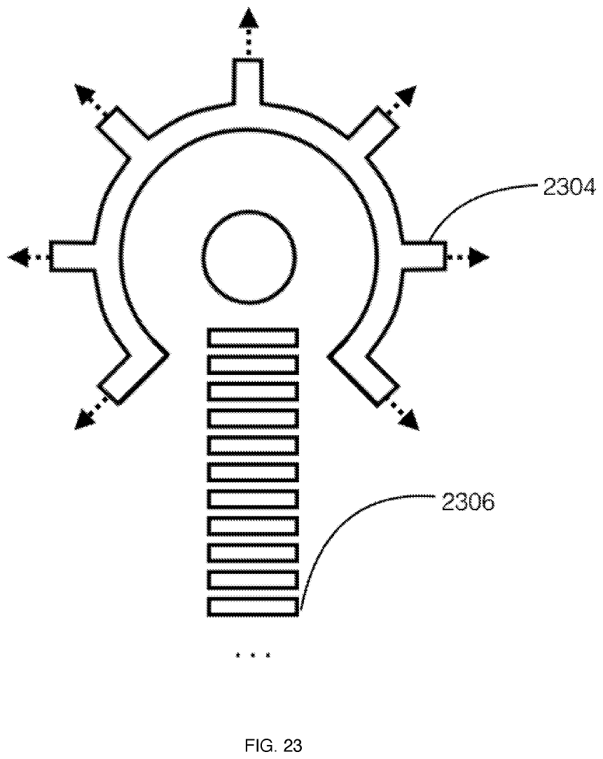

FIG. 23 is a diagram of an exemplary embodiment of the implementation of the virtual fitting system, illustrating the system having a plurality of virtual outfit catalogs waiting in the queue 2306, and a plurality of outlets and/or distribution handlers 2304. The system automatically retrieving the virtual outfit catalogs from the queue, processing the virtual outfit catalogs, and sending them out to the client components, through the appropriate outlets and/or distribution handlers, in the virtual fitting system.

The virtual fitting system may further configure the price to be automatically reduced within the price range in the sale period, based on the amount of orders received from the consumers. This way, the more consumers order the product, the more likely each consumer gets a lower unit price for the product. This will incentive the consumers who like the product sharing the product offer with their friends and people in their network, spread out the words, creating viral effect for the product offer. This helps the vendor getting more orders for his/her products.

While the present invention may be embodied in many different forms, designs or configurations, for the purpose of promoting an understanding of the principles of the invention, reference will be made to the embodiments illustrated in the drawings and specific language will be used to describe the same. It will nevertheless be understood that no limitation of the scope of the invention is thereby intended. Any alterations and further implementations of the principles of the invention as described herein are contemplated as would normally occur to one skilled in the art to which the invention relates.

What is claimed is:

1. A system for automatic collecting, processing and combining custom product orders into bulk orders according to a procedure for storing custom product offers with adjustable price and configurable terms in a virtual outfit catalog of a virtual fitting system, the system comprising a computer and memory configured with instructions to perform the following steps:
a. receiving, from a vendor, a plurality of images of products and prototypes, product data, variations of colors and styles, sale period, minimum order quantity, a price range and other terms for a product offer from a vendor user interface;
b. in response to the vendor entering the product offer using the user interface, creating a digital sale contract with configurable price and terms, storing in a virtual outfit catalog, wherein the contract includes at least a minimum order quantity, sale period, the price range and terms;
c. storing a plurality of product offers in the virtual outfit catalog, periodically broadcasting the virtual outfit catalog to consumers in timeframes, storing a broadcasting frequency in the memory;
d. providing a consumer interface for a consumer for retrieving and viewing the virtual outfit catalog, virtual fitting the images of products and prototypes with consumer images using the virtual fitting system, order products and prototypes using the digital sale contract;
e. collecting product orders from consumers using the virtual fitting system, storing the product orders in the memory;
f. gradually reducing the price within the price range based on one or a plurality of mathematical equations;
g. in response to receiving more product orders than the minimum order quantity of a product or prototype, automatically converting the product orders into a bulk order using the digital sale contract, wherein the bulk order includes at least the image, price and quantity of the product or prototype.

2. The system in accordance with claim 1, wherein the virtual fitting system is further configured for broadcasting a plurality of virtual outfit catalogs to the consumers in timeframes.

3. The system in accordance with claim 1, wherein the broadcasting frequency is adjusted base on real-time market feedback, increasing the broadcasting frequency of popular virtual outfit catalog, reducing the broadcasting frequency of unpopular virtual outfit catalog.

4. The system in accordance with claim 1, wherein the consumer user interface is further configured for consumers to enter customization requests, redesign the products and prototypes, change components and features of the products and prototypes.

5. The system in accordance with claim 1, wherein the consumer user interface is further configured for the consumer to enter, review, comment, and provide feedback on the products and prototypes, communicating with provides, vendors, designers and/or other corresponding parties.

6. The system in accordance with claim 1, wherein the virtual fitting system is further configured for the vendors and/or designers to interact with consumers, facilitating vendors and/or designers to refine and make variations of the products and prototypes based on feedback and reports received from the consumers.

7. The system in accordance with claim 1, wherein the virtual fitting system is further configured for collecting feedback and custom design inputs from the consumers, processing and consolidating data received, generating summarized representations using charts, tables, diagrams, graphical images and reports.

8. The system in accordance with claim 1, wherein the virtual fitting system is further configured for the consumer to virtual fit images of objects, apparels and/or environment to images of other objects, apparels, and/or environment captured, loaded, and selected by the consumer.

9. The system in accordance with claim 1, wherein the product offers of products and prototypes that received few or no orders, and the product offers that are expired are hidden or removed from the virtual outfit catalog.

10. The system in accordance with claim 1, wherein the broadcasting frequency of the virtual outfit catalog is gradually increased in the sale period, when receiving many orders for the products and prototypes.

11. The system in accordance with claim 1, wherein the virtual fitting system is further configured for using benchmark lines and/or benchmark mathematical equations to measure the performance of the product offers.

12. The system in accordance with claim 1, wherein the broadcasting frequency of the virtual outfit catalog is further adjusted based on one or a plurality of mathematical equations.

13. The system in accordance with claim 1, wherein the price of the product or prototype in the product offer is further automatically adjusted within the price range base on the amount of orders received and real-time market feedback in the sale period.

14. The system in accordance with claim 1, wherein the consumer user interface is further configured with a slider, checkmark or button for the consumer to set the price range acceptable for the consumer when ordering the product or prototype.

15. The system in accordance with claim 1, wherein the vendor user interface is further configured with a slider, checkmark or button for the vendor to set the price range of the product or prototype for the product offer.

16. The system in accordance with claim 1, wherein the consumer user interface is further configured for the consumer to choose multiple product options when ordering a product or prototype, wherein the product options include quantity, style, color, material, fabric and other options provided in the product offer.

17. The system in accordance with claim 16, wherein the virtual fitting system automatically select and combine the product orders into bulk orders, choosing the product options receiving more orders.

18. The system in accordance with claim 1, wherein the digital sale contract has configurable conditions and terms, automatically converting to an executed binding purchase and sales agreement between the seller and buyer when the conditions and terms are met.

19. The system in accordance with claim 1, wherein the digital sale contract is further configured with an escrow account and/or digital wallet, storing fund that is automatically transferred between seller and buyer when the conditions and terms are met.

20. A method for automatic collecting, processing and combining custom product orders into bulk orders according to a procedure for storing custom product offers with adjustable price and configurable terms in a virtual outfit catalog of a virtual fitting system, the method comprising the steps of:
a. receiving, from a vendor, a plurality of images of products and prototypes, product data, variations of colors and styles, sale period, minimum order quantity, a price range and other terms for a product offer from a vendor user interface;
b. in response to the vendor entering the product offer using the user interface, creating a digital sale contract with configurable price and terms, storing in a virtual outfit catalog, wherein the contract includes at least a minimum order quantity, sale period, the price range and terms;
c. storing a plurality of product offers in the virtual outfit catalog, periodically broadcasting the virtual outfit catalog to consumers in timeframes, storing a broadcasting frequency in the memory;
d. providing a consumer interface for a consumer for retrieving and viewing the virtual outfit catalog, virtual fitting the images of products and prototypes with consumer images using the virtual fitting system, order products and prototypes using the digital sale contract;
e. collecting product orders from consumers using the virtual fitting system, storing the product orders in the memory;
f. gradually reducing the price within the price range based on one or a plurality of mathematical equations;
g. in response to receiving more product orders than the minimum order quantity of a product or prototype, automatically converting the product orders into a bulk order using the digital sale contract, wherein the bulk order includes at least the image, price and quantity of the product or prototype.
